(19) United States
(12) Patent Application Publication
(10) Pub. No.: US 2010/0332363 A1
(43) Pub. Date: Dec. 30, 2010

(54) PAYMENT CARDS AND FUEL CARDS

(75) Inventors: Ashley Robert Duddle, Hampshire (GB); Stephen Henry Perham, Surrey (GB); Darshan Arunkumar Armin, Hertfordshire (GB)

Correspondence Address: BRYAN CAVE LLP, TWO NORTH CENTRAL AVENUE, SUITE 2200, PHOENIX, AZ, 85004, US

(73) Assignee: Airmax Group, PLC, Verwood, Dorset (GB)

(21) Appl. No.: 12/601,805

(22) PCT Filed: May 23, 2008
(86) PCT No.: PCT/GB2008/001769

§ 371 Date: Sep. 17, 2010

(30) Foreign Application Priority Data
May 24, 2007 (GB) 0709939.3
Jan. 16, 2008 (GB) 0800690.0

(51) Int. Cl. G06Q 40/00; G06F 7/00; G06Q 30/00

(52) U.S. Cl. 705/34; 701/33; 705/44; 705/41; 705/30

(57) ABSTRACT

A method of generating an indicator that there is an anomaly between vehicle data and fuel card usage data, comprises: receiving (402) vehicle data at a computer (110; 206, 210); receiving (404) fuel card usage data at the computer; using the computer to compare (406) the vehicle data with the fuel card usage data according to a set of rules (116) accessible by the computer to determine if there is an anomaly between the vehicle data and the fuel card usage data; and the computer automatically generating (410) an indicator if an anomaly is determined.

### FIELD OF THE INVENTION

This invention relates to improvements in, and relating to, payment cards, particularly, but not exclusively, the invention relates to security and anti-fraud technology relating to fuel cards.

### BACKGROUND OF THE INVENTION

Fuel cards that are associated with fuel suppliers are known and can be used at an electronic point of sale (EPOS) to purchase fuel from that supplier. They are typically a physical card encoded with a person's identity, or a vehicle identity, and details to enable the fuel vendor to charge the cost of the fuel to a third party, such as the person's employer. Purchases made with a fuel card, or with associated fuel cards, made over a period of time can be combined together such that a single invoice can be generated for the total fuel purchased in a number of individual fuel transactions.

Fuel cards are particularly useful to vehicle fleet managers to help control the costs and administration associated with running a fleet of vehicles. Such a fleet may comprise cars, trucks, buses, or other plant equipment. Each of the drivers within a fleet may be given their own fuel card, and details of all purchases made with the fuel cards can be used to analyse consumption and expenditure on fuel for the whole fleet in order to improve cost efficiency. Such fuel cards are typically only available to large companies that may have a good credit history, for example, the top 5000 companies in the UK which might have vehicle fleets in excess of several hundred vehicles. Fuel cards of this kind have strict compliance rules which means that not every company is allowed to use a fuel card system.

It is also known that Value Added Tax (VAT) is payable when purchasing fuel in the UK (and perhaps other countries), and that when fuel is purchased for business purposes the VAT can be claimed back from the Government by the employer. This makes fuel that is used for business purposes cheaper than fuel that is used for personal/private purposes, as the tax that is paid on business fuel is refunded. VAT cannot legally be claimed back for fuel that is purchased for personal use—it is only fuel that is used for business purposes that is eligible for VAT relief.

Use of fuel cards by a number of employees (for example within a fleet), with a common account, can enable all of the individual fuel purchases for which Value Added Tax (VAT) needs to be claimed back from the Government to be combined into a single fuel invoice. This can provide significant savings of administration time and costs, as the VAT can be claimed back for multiple fuel purchases in a single operation, as opposed to claiming the VAT back on the individual fuel purchases each time an individual fuel purchase is made.

However, fuel-related card fraud is becoming an increasing problem in the UK.

A known problem with existing fuel cards is that users of the fuel cards can abuse the system by purchasing fuel that is not for business use with their fuel card, thereby fraudulently claiming back the VAT for fuel used for personal/private use.

It is also known for a person who is eligible to purchase fuel with a fuel card for a certain vehicle for business purposes, to also use their fuel card fraudulently for purchasing fuel which is not for business purposes, and which may not be for a vehicle for which the driver is entitled to claim VAT back.

It is known for a person who is eligible to claim VAT back for fuel purchases to allow another person (e.g. their partner/husband/wife) fraudulently to use the fuel card to purchase fuel for their own vehicle.

Further problems associated with claiming VAT back for business fuel purposes include situations where a person legitimately buys fuel for a vehicle with a fuel card, but then siphons the fuel out of the vehicle to use that fuel in a different vehicle for personal use, thereby defrauding the government out of the tax that should have been paid for the fuel.

It is not unknown for people who have a new diesel car provided by their employer, and who use a fuel card to purchase fuel for that vehicle, to buy a second diesel car for their spouse soon afterwards. There is a suspicion that free diesel is an attraction, as they can purchase fuel for both vehicles using their fuel card, and claim the cost of the fuel back from their employer. In turn, the employer illegally claims the VAT back on the fuel purchases. There is no real handle on the scale of the problem.

At present, one way to verify that a fuel claim does not cover fuel that has been used for private/personal purposes is to have the driver of the vehicle complete paperwork to create a log of his driving of the vehicle for business purposes and to rely on the log of the business driving journeys that a driver keeps, and compare this with the amount fuel that the driver states as being used for those journeys. There are disadvantages associated with this system, as the driver may not keep the log up-to-date accurately. A driver log can only be considered as a very rough guide to how much fuel may have been used, and can be easily manipulated or misinterpreted.

A further problem with the known fuel card is that it is a charge card system whereby the summary of the total expenditure on the card is typically presented to the employer for payment one month out of date. Such a charge card system introduces a delay in the tracking of possible fraud and payment of the final fuel bill by the employer.

### SUMMARY OF THE INVENTION

According to a first aspect of the invention, there is provided a method of generating an indicator that there is an anomaly between vehicle data and fuel card usage data, the method comprising the steps:
receiving vehicle data at a computer;
receiving fuel card usage data at the computer;
using the computer to compare the vehicle data with the fuel card usage data according to a set of rules accessible by the computer to determine if there is an anomaly between the vehicle data and the fuel card usage data; and
the computer automatically generating an indicator if an anomaly is determined.

Using vehicle data to determine if there is an anomaly can alleviate the need to rely on the correctness and honesty of any information that may need to be supplied by a driver/human user/operator. Embodiments of the invention can reduce the chances that a user can fraudulently modify any data when determining whether or not a fuel card has been abused. It may not be possible for a user to alter the vehicle data, such that the vehicle data always gives an accurate reflection of how the vehicle has been used. Such a method may be useful for small to medium size firms to manage fleets in addition to larger firms.

The computer may generate an indicator that there is a discrepancy between the actual amount of fuel used by the vehicle as determined from the vehicle data, and the amount of fuel used by the vehicle as determined from fuel card usage.

The comparison between the vehicle data and the fuel card usage data identifies if there are any discrepancies/anomalies between the two sets of data.

The anomaly may indicate that there is a leak in the fuel tank, which would be a major safety concern.

Additionally, an anomaly may be an indication that a fuel card has been used fraudulently. Such fraudulent use may be carried out by the driver, or by a fuel supplier who may overcharge for fuel and share a portion of the fraudulently gained profit with the driver. The method minimises the possibility of typographical errors by the driver and/or the fuel supplier. Embodiments of the invention can help reduce fuel card fraud by using a technical comparison between data according to a set of rules to ensure that the amount of fuel purchased with a fuel card coincides with the actual amount of fuel that is used by a vehicle.

The step of comparing the vehicle data with the fuel card usage data may include the computer using a representation of the vehicle data and/or a representation of the fuel card usage data to make the comparison. The representation may be an averaged value of the data, or part of the data, or any other statistical representation of the data in order to more easily represent the data.

The step of comparing the vehicle data with the fuel card usage data according to a set of rules, may further comprise the computer converting at least one of the vehicle data and fuel card usage data into a unit/format that can be compared with the other of the vehicle data and the fuel card usage data. Converting the vehicle data and/or fuel card usage data can enable the two sets of data to be more easily compared with each other. The converted format/s may define the data in a more convenient way to perform the comparison. One of the vehicle data and fuel card usage data may be converted into a format that is similar to, or the same as, the format of the other of the vehicle data and fuel card usage data.

The computer may convert the vehicle data into a value, or range of values, that identifies the amount of fuel that the vehicle has used. Using a range of values can enable tolerances to be built into the data. The tolerances may take account of tolerances in the data recording means, any errors that may be incorporated as part of any conversion or representation of the data, and also any discrepancies that would not be deemed significant—For example, a difference of 1% between a representation of the vehicle data and a representation of the fuel card usage data may be deemed insignificant and not important.

The method may further comprise the computer using a database to convert values of the vehicle data into corresponding values of fuel usage in order to identify the amount of fuel that the vehicle has used. A database or a look-up table may be a convenient way to convert parameters of the vehicle data into a more convenient format.

In embodiments where more than one vehicle employs a method of the invention, storing such a database or look-up table centrally at a single location (or at fewer physical locations than there are vehicles) can enable any changes in the conversion parameters to be updated centrally at one location, or at least at not many different locations.

The set of rules may comprise rules to generate a range of values that correspond to the received vehicle data, and a range of values that correspond to the received fuel card usage data, and wherein an anomaly is determined if the two ranges of values do not overlap.

The set of rules may comprise instructions to compare the difference between the vehicle data and the fuel card usage data, or representations thereof, with a threshold value, and instructions to cause exceeding the threshold value to cause an anomaly to be determined. The degree of difference between the two sets of data that causes an anomaly to be determined can be set by the value of the threshold. Changing the value of the threshold can change the sensitivity of the method to differences between the vehicle data and the fuel card usage data.

The set of rules may further comprise more than one threshold value, and exceeding more than one threshold values may cause differentiated anomalies with increasing levels of severities to be determined.

The method may further comprise receiving at the computer an identifier associated with the vehicle, and the computer using the identifier to determine which of a plurality of rules should be applied for the identified vehicle when comparing the vehicle data with the fuel card usage data. The identifier may define threshold values for that specific vehicle, and/or may define tolerances that should be employed for that vehicle, and/or may identify the make and/or model of the vehicle such that a more accurate representation or conversion of data can be performed. For example, the identifier may indicate the type of vehicle being used, thereby enabling the correct, or best, one of a plurality of databases to convert vehicle data into fuel usage to be used.

In some embodiments, the identifier may be used as a “virtual fuel card” in order to obtain fuel card usage data directly from an Electronic Point of Sale (EPOS). That is to say, there may not be a real physical fuel card. The identifier could be a wireless telecommunications device fitted to the vehicle.

The method may further include using fuel card usage data from a pre-paid fuel card for providing fuel card usage data substantially in real time.

Such an arrangement may avoid the monthly billing delay associated with known credit cards and allows data feedback on fuel purchase and/or fuel usage to be substantially in real time. Reducing the amount of time between filling the vehicle with fuel, purchasing the fuel and data feedback in this manner may further assist in reducing fraud.

The method may further include using a fuel card having data relating to an identification of a driver of the vehicle. This data may be used to mobilise or immobilise the vehicle.

The method may further include using the indicator to immobilise or mobilise the vehicle.

According to a second aspect of the invention, there is provided apparatus for generating an indicator that there is an anomaly between vehicle data and fuel card usage data, comprising:
vehicle data gathering means;
fuel card usage data gathering means;
a computer processor arranged to receive vehicle data from the vehicle data gathering means and fuel card usage data from the fuel card usage data gathering means;
wherein the computer processor is arranged to compare the vehicle data and the fuel card usage data with a set of rules to determine if there is an anomaly, and to generate an indicator if an anomaly is determined.

The computer processor may be arranged to compare a representation of the vehicle data and/or a representation of the fuel card usage data to determine if there is an anomaly.

The processor may be further arranged to convert at least one of the vehicle data and fuel card usage data into a format/unit that can be compared with the other of the vehicle data and the fuel card usage data. The converted format/unit may be the same unit as the other data, for example miles per gallon (mpg). The mpg may be considered for a certain period of time, for example, to determine the fuel usage since the last point was calculated, or since the data was last reset.

Preferably, the processor is arranged to receive data relating to, or convert vehicle data into, one or more of: fuel used, cost of the fuel used, mpg, etc. Preferably, the data is for one or more of: a certain period of time, specific trips/journeys, etc. In some embodiments the data may be used in combination with the time of day, known business hours, personal hours, etc.

The processor may be arranged to convert the vehicle data into a value, or range of values, that identifies the amount of fuel that the vehicle has used.

The processor may be arranged to access a database in computer memory to convert values of the vehicle data into corresponding values of fuel usage in order to identify the amount of fuel that the vehicle has used.

The processor may be arranged to generate a range of values that correspond to the received vehicle data, and to generate a range of values that correspond to the received fuel card usage data, and to determine that there is an anomaly if the two ranges of values do not overlap.

The processor may be arranged to compare the difference between the vehicle data and the fuel card usage data, or representations thereof, with a threshold value and to determine that there is an anomaly if the threshold value is exceeded.

The processor may be further arranged to compare the difference between the vehicle data and the fuel card usage data, or representations thereof, with more than one threshold value, and to determine a severity of an anomaly if more than one threshold value is exceeded.

The vehicle data may be information that is derived from a vehicle, preferably from the engine of the vehicle. The vehicle data may be obtained from engine management systems that are already present in the vehicle, for example from a Controller Area Network (CAN) or any other data bus within the vehicle, preferably accessed via a communications port within the vehicle. In some embodiments, the vehicle data may be accessed from a European On Board Diagnostics interface (EOBD) port within the vehicle, in other embodiments the data may be accessed from diagnostic systems within the vehicle that provide detailed data such as an individual fuel Engine Control Unit. The data may be accessed from any vehicle diagnostics port/diagnostics communication port, and it is not intended to limit the scope of the invention to the type of vehicle data obtained, the method by which the vehicle data is obtained, and any onboard system from which the vehicle data is obtained.

The vehicle data can include, but is not limited to: revolutions per minute (rpm); speed; distance; acceleration; deceleration; fuel consumption/usage; miles per gallon (mpg); throttle position; gear ratio; idle ratio; and any faults associated with the vehicle. The vehicle data may comprise one, some, or all of the above parameters, and may be arranged to be stored on the fuel card, or a separate card such as a smart card with a data storage means. The card may be arranged to store historical data such as card usage, C0₂ used by the vehicle, or mileage traveled by the vehicle.

The vehicle data may provide information on how the vehicle is driven, which may provide a more accurate mpg figure/fuel usage figure.

In some embodiments, an apparently poor value for the mpg (which may be determined either directly or indirectly from the vehicle data) may trigger an anomaly/concern about fuel card fraud.

The apparatus may further comprise:
vehicle identification means arranged to provide an identifier associated with the vehicle; and
wherein the processor is further arranged to use the identifier associated with the vehicle to determine which of a plurality of rules should be applied for the identified vehicle to compare the vehicle data with the fuel card usage data.

The fuel card usage data may be from a pre-paid fuel card for providing fuel card usage data substantially in real time.

The fuel card may contains data relating to a driver identification. The vehicle may be provided with a switch which is operable by the indicator to immobilise or mobilise the vehicle.

According to a further aspect of the invention, there is provided a method of generating an invoice for fuel dispensed from a fuel pump comprising:
receiving an identifier from a vehicle at the fuel pump over a wireless communication channel;
dispensing fuel by the fuel pump;
associating the dispensed fuel with the identifier; and
generating and delivering an invoice for the dispensed fuel to a party associated with the identifier.

This can assist in anti-fraud security.

Receiving the identifier from the vehicle may comprise using a camera to read the number/registration plate of a vehicle at the fuel pump.

Preferably, a driver can drive up to a fuel pump, refuel their vehicle, and then drive away without having to spend time dealing with payment of the fuel there and then, the wireless communication channel enabling the vehicle to be identified and hence this can improve the throughput of vehicles through a refuelling station, and can improve customer satisfaction with the refuelling station. It can also reduce the amount of fuel theft, as it may be difficult for a driver to refuel their car and then drive away without paying. In some embodiments, it may be possible to bar certain drivers from refuelling at a refuelling station if they are known bad-payers, or if they do not have enough money on their account for example. The fuel pumps may be deactivated for identified vehicles, possibly automatically by a control computer.

The method may further comprise a plurality of dispensing fuel operations, preferably by one or more fuel pumps, before the step of generating the invoice. This can enable the overheads that are required to generate invoices to be reduced as a number of individual fuel transactions can be combined into a single fuel purchase invoice. The overheads for the both the supplier of the fuel and the purchaser of the fuel can be reduced. The overheads can include, administration staff time and associated costs, bandwidth of communications channels used, computer processing capabilities and computer memory required, etc.

The identifier may comprise one, or more, of:
billing information for the driver or an employer of the driver;
the name of the driver;
the name of an employer of the driver;
the registration number of the vehicle;
a vehicle identification number (VIN);
distance traveled by the vehicle;
an account number for the driver/vehicle; and
an invoice-to address.

Using a VIN has the advantage of allowing for genuine number plate changes such that the customer can ready retain their registration plate when acquiring a new vehicle.

According to a further aspect of the invention, there is provided a fuel pump comprising:
a transceiver arranged to receive an identifier from a vehicle;
a computer processor arranged to associate fuel dispensed by the fuel pump with the identifier and to generate an invoice to a party associated with the identifier for the dispensed fuel.

The fuel pump may be arranged to receive the identifier over a wireless communication channel.

The processor may be arranged to associate a plurality of amounts of fuel dispensed, preferably by one or more fuel pumps in order to generate the invoice.

The identifier may comprise one, or more, of:
billing information for the driver or an employer of the driver;
the name of the driver;
the name of an employer of the driver;
the registration number of the vehicle;
a vehicle identification number (VIN);
distance traveled by the vehicle;
an account number for the driver/vehicle; and
an invoice-to address.

According to a further aspect of the present invention, there is provided a method of refuelling a vehicle, comprising:
driving a vehicle to a refuelling station;
the vehicle automatically identifying itself to the refuelling station;
refuelling the vehicle; and
the refuelling station automatically generating an invoice for the fuel and delivering the invoice to a party responsible for the invoice.

According to a further aspect of the invention there is provided a method of purchasing fuel at a service station comprising;
obtaining a code by making a prepayment; inserting the prepayment in a memory in a computer and being allocated to the special code in the memory for use in verifying an identity of a user for purchasing fuel; communicating with the computer when fuel is required to be purchased; inputting the special code for verification; verifying at the computer by checking the special code and comparing the prepayment less any deductions for previous fuel purchases in the memory; authorising payment in response to said verification; monitoring the remaining payment less deductions for previous fuel purchases; and not authorising payment when the remaining payment has been spent by the previous fuel purchases.

The method may include cross-referencing the prepayment with vehicle telematics data to generate an indicator that there is an anomaly with the vehicle telematics data. The vehicle telematics data and the prepayment data may be provided in a single special server or in two respective special servers in communication with the each other.

According to a further aspect of the invention there is provided a system to purchase fuel at a service station comprising;
means for coupling a party requiring to purchase fuel at a fuel station to a first special server;
memory means in the first special server for storing special customer codes and prepayment information individual to each customer;
means for verifying the party responsive to a code transmitted from the party to the special exchange so as to verify that the code matches the special customer code in the memory means and the party has unused credit; and
means for authorising fuel purchase to the party responsive to the verification.

The special server may be also contain vehicle telematics data individual to each customer. The vehicle telematics data may be contained in a second special server in communication with the first special server. According to a further aspect of the invention there is provided a method of mobilising a vehicle using a fuel card containing driver identification information, the method comprising:
receiving the driver identification information at a computer;
using the computer to compare the driver identification information with a database of authorised drivers; and
mobilising the vehicle if the driver identification information matches one of the authorised drivers.

According to a further aspect of the invention there is provided a method of controlling a vehicle using a fuel card containing driver identification information, the method comprising:
receiving the driver identification information at a computer;
receiving vehicle data at the computer;
generating a use profile for the driver and comparing it with a stored use profile corresponding to the driver identification;
comparing the use profile with the pre-stored use profile; and
controlling the vehicle if the use profile differs from the pre-stored use profile.

Such an arrangement may be used to immobilise the vehicle, or limit the top speed, or acceleration of the vehicle if the use profiles differ. Such a difference may be due to the driver being under the influence of alcohol or other drugs, or being tired, or the driver using a stolen fuel card.

According to a further aspect there is provided a method of paying for goods, services or charges using a payment card, the method comprising the steps:
receiving vehicle data at a remote computer;
receiving payment card data at the computer;
using the computer to compare the vehicle data with the payment card data to determine whether there is sufficient credit to pay for the goods, services or charges; and
using the computer to authorise payment if there is sufficient credit.

According to a further aspect there is provided an apparatus for paying for goods, services or charges comprising:
a payment card;
vehicle data gathering means; and
a computer processor to receive data relating to the payment card;
wherein the computer processor is arranged to compare the vehicle data with the payment card data to determine whether there is sufficient credit to pay for the goods, services or charges, and
wherein the computer is arranged to authorise payment if there is sufficient credit.

It will be appreciated that any of the optional features associated with an aspect of the invention, are also optional features associated with other aspects of the invention.

Embodiments of the invention will now be described in detail, by way of example only, and with reference to the accompanying drawings, of which:—

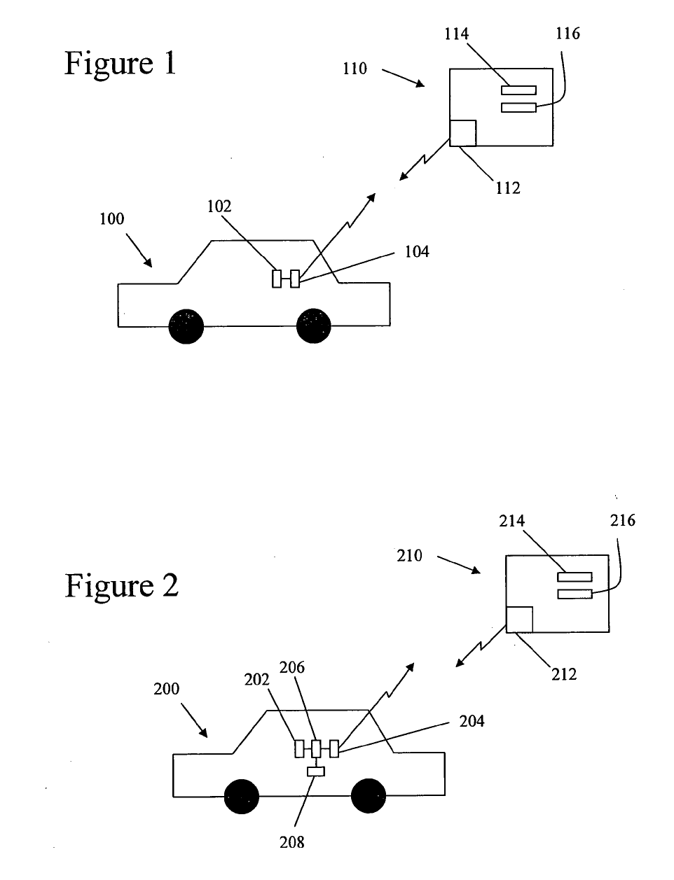

FIG. 1 shows schematically a system for generating an indicator/alert according to an embodiment of the present invention;

FIG. 2 shows schematically a system for generating an indicator according to a further embodiment of the present invention;

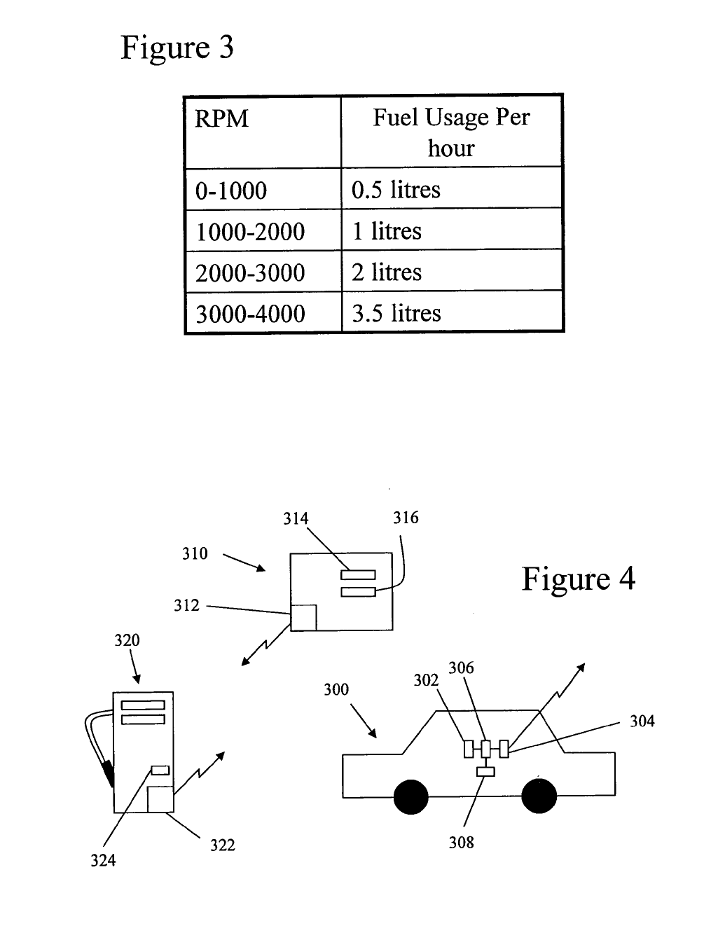

FIG. 3 shows graphically an example of a database that can be used with embodiments of the present invention;

FIG. 4 shows schematically another system according to a further embodiment of the present invention;

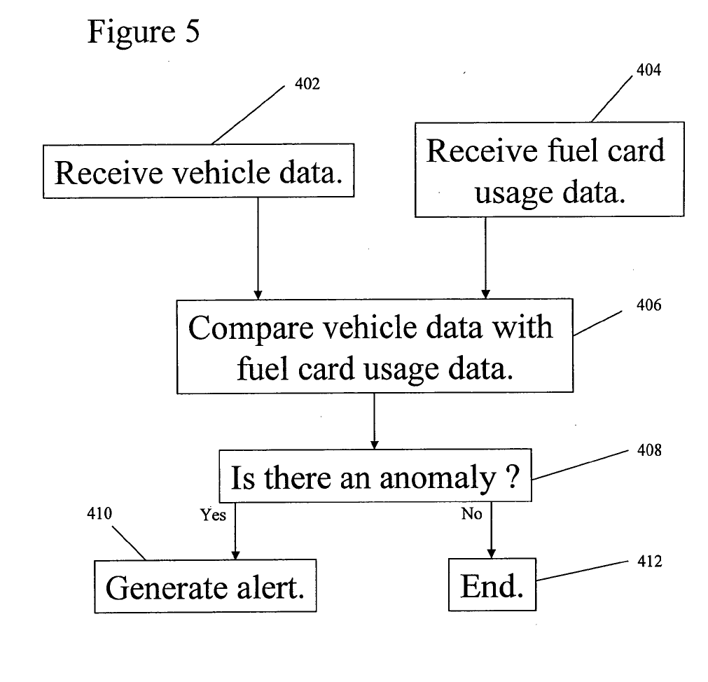

FIG. 5 shows graphically the steps performed when generating an indicator/alert according to an embodiment of the present invention;

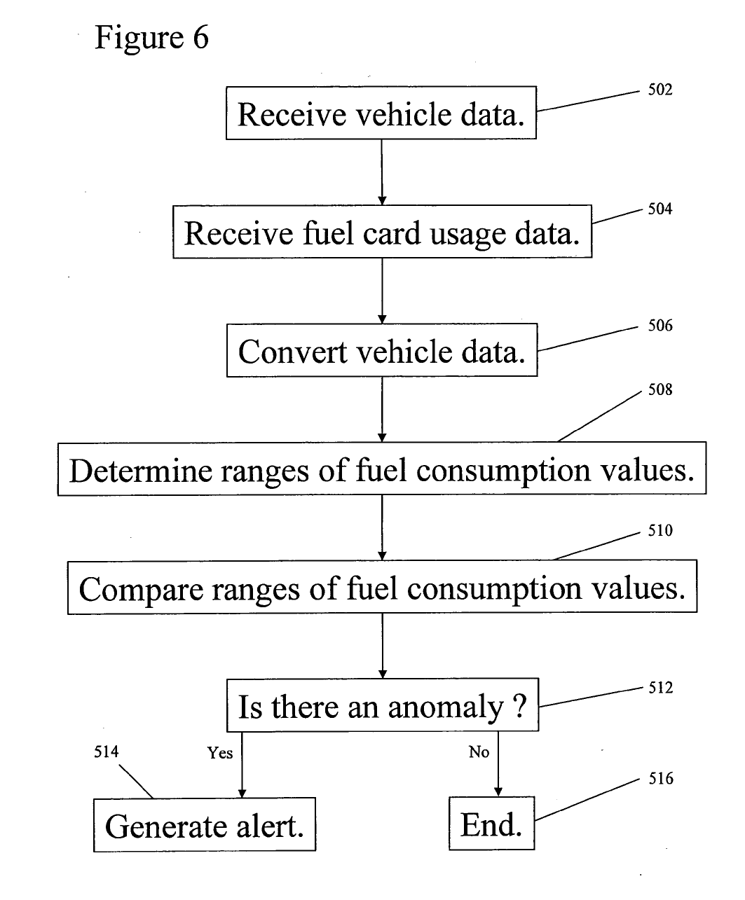

FIG. 6 shows graphically the steps performed when generating an indicator/alert according to another embodiment of the present invention;

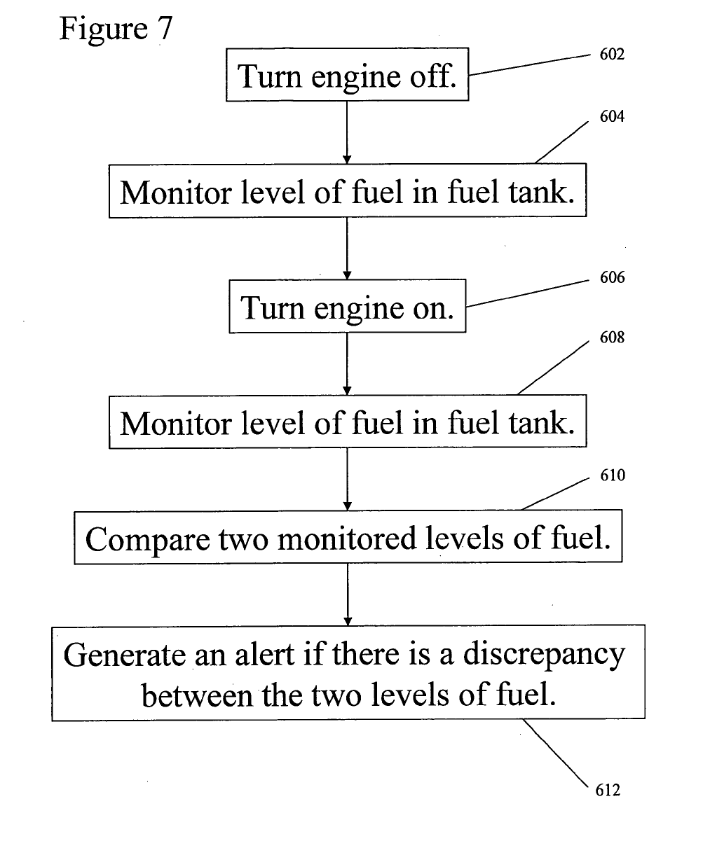

FIG. 7 shows graphically the steps performed when generating an alert according to an embodiment of the present invention; and

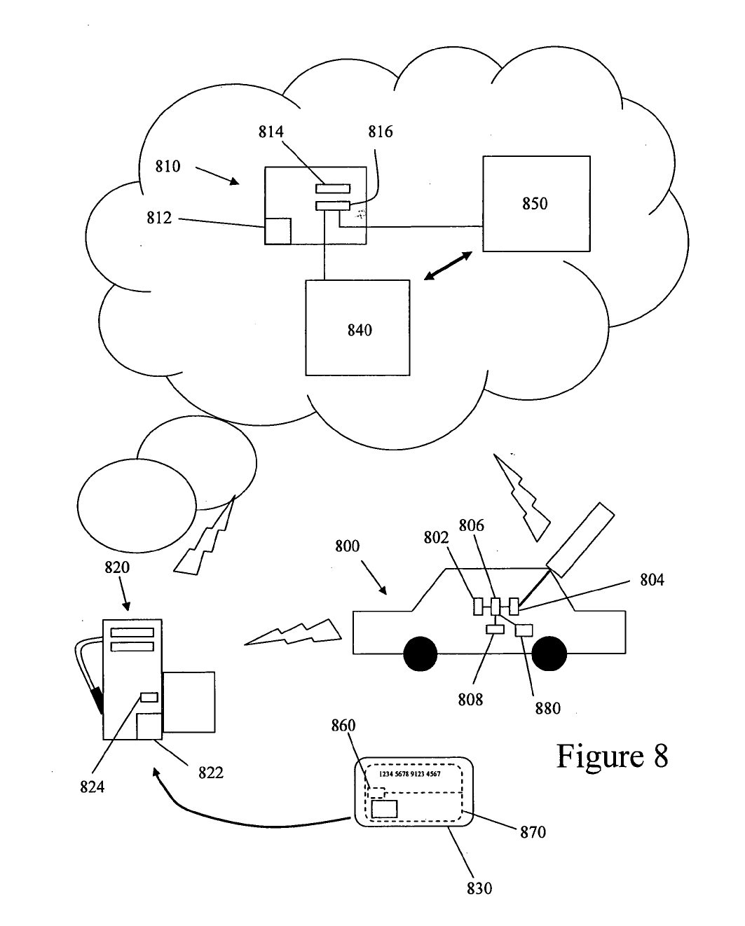

FIG. 8 shows schematically another system according to a further embodiment of the present invention for use with prepaid credit cards.

One aspect of the present invention relates to a method and apparatus for generating an indicator if there is an anomaly/inconsistency/discrepancy between vehicle data and fuel card usage data. The anomaly may be that the engine of the vehicle has not actually used the amount of fuel that the fuel card usage data indicates as being purchased for that vehicle, or at least that the proportion of fuel that has been used for business purposes does not match the proportion of the fuel that has been purchased for business purposes. This may be an indication of fuel card fraud. The actual amount of fuel, or a good estimate of the amount of fuel, that a vehicle has used can be determined from the vehicle data as discussed below.

FIG. 1 shows schematically a system for generating an indicator according to an embodiment of the present invention. The indicator may provide information in relation to fuel card fraud, and improve the security associated with the use of fuel cards. FIG. 1 shows a car 100 comprising a vehicle data gathering means 102 and a transceiver 104 capable of emitting wireless signals. Also shown is an off-vehicle computer 110, comprising a computer processor 114, a computer memory 116, and a transceiver 112 capable of receiving wireless signals. In this embodiment, the off-vehicle computer 110 is associated with the fuel card supplier. In other embodiments, the off-vehicle computer 110 may be independent of the fuel card supplier, and may be in electronic communication with the fuel card supplier by any known means.

The transceiver 112 in the off-vehicle computer 110 is in electronic communication with the transceiver 104 in the car 100. Also, the transceiver 112 in the off-vehicle computer 110 is in electronic communication with Electronic Point of Sale (EPOS) terminals at which fuel can be purchased with a fuel card. Information detailing all purchases made with a fuel card, or associated fuel cards, is stored in the computer memory 116 of the off-vehicle computer. This information can include, but is not limited to, one, some, or all, of: amount of fuel purchased, cost of the fuel, distance traveled by the vehicle, identification of the person who used the fuel card, time of purchase, account number of the holder of an account with the fuel supplier, etc. The information can be used periodically to invoice users of the fuel card as is known in the art.

In other embodiments, a fuel card company may have a further, separate off-vehicle computer (not shown in this embodiment) that is used to determine the billing information for the companies that use a fuel card. In such embodiments, the off-vehicle computer 110 that is used to perform the processing of the vehicle data and fuel card usage data may be in electronic communication with the further off-vehicle computer, in order to receive the required fuel card usage data. It will be appreciated that in some embodiments of the invention, the computer processing capabilities and/or computer memory may be split between more than one physical location.

It will be appreciated that in other embodiments either, or both, of the transceivers 104 and 112 may be just a transmitter or a receiver, depending upon which direction data is transferred between the vehicle 100 and the off-vehicle computer 110.

The vehicle data gathering means 102 is arranged to gather data relating to the vehicle, and supply this data to the transceiver 104 so that it can be transmitted to the off-vehicle computer 110. The vehicle data may be transmitted off-vehicle periodically, for example, every hour, every day, every week, or it may be transmitted off-vehicle substantially in real-time. In some embodiments, the vehicle data may be transmitted off-vehicle each time a fuel purchase is made, and preferably each time a fuel purchase is made with a fuel card.

In some embodiments, the vehicle data may be retrieved from the vehicle by plugging a data retrieval device into a vehicle diagnostics port in the vehicle. In such embodiments, a wireless transceiver 104 may not be required in the vehicle 100, as the required data may be retrieved by any form of direct or indirect wired connection.

The vehicle data is information that is derived from a vehicle, preferably from the engine of the vehicle. The vehicle data gathering means 102 may use engine management systems that are already present in the vehicle to obtain the vehicle data. The vehicle data gathering means 102 may obtain vehicle data from a Controller Area Network (CAN) bus or any other data bus within the vehicle, and/or from a European On Board Diagnostics interface (EOBD) port within the vehicle.

A known interface for monitoring the status and performance of a vehicle engine in Europe is the EOBD. There is also an American equivalent on-board diagnostics standard, identified by the abbreviation OBD. Each vehicle manufacturer tailors a number of output ports of the EOBD or OBD socket to carry data relating to a number of parameters of vehicle performance. Such data can be derived from sensors throughout the vehicle, for example: speed, distance, tachometer data, fuel consumption data, and electrical fault data. Accessing data via the EOBD is one example of how data can be accessed according to the invention. Another example involves using data from diagnostic systems within the vehicle that provide detailed data such as an individual fuel Engine Control Unit.

The vehicle data may be obtained from a physical EOBD connector within the vehicle using either the diagnostic connections provided for EOBD or via other lines provided by the vehicle manufacturer for their own diagnostics purposes. Embodiments of the invention may use signals and protocols which are in common with those used for EOBD. In some embodiments, the signals may, or may not, be EOBD and/or may be accessed via an electronic gateway on the vehicle.

The fuel consumption data may provide an indication of the level of fuel within the fuel tank. The level of fuel within the fuel tank (and/or any other vehicle data) may be time stamped with the time at which it was recorded. The level of the fuel within the fuel tank may be converted directly into volume of fuel within the fuel tank if the shape of the fuel tank is known, for example if the cross-sectional profile of the fuel tank is known.

In other embodiments, the fuel consumption data may be an indication of the miles per gallon (mpg) that corresponds to how the vehicle is driven, and/or may comprise an estimation of how far the vehicle is likely to be capable of travelling on the fuel that remains in the fuel tank. This “miles to empty” information may already be available from the engine management system, and in some embodiments may be displayed to the driver on the dashboard.

Also, values outside of an acceptable range trigger a diagnostic trouble code (DTC). These DTCs can be used to illuminate warning lamps or displays on the vehicle's dashboard.

Information that may be obtained from the engine management system through the vehicle diagnostics port can include, but is not limited to: revolutions per minute (rpm); speed; distance; acceleration; deceleration; fuel consumption/usage such as fuel flow data at one or more engine fuel injectors; miles per gallon (mpg); throttle position; gear ratio; idle ratio; engine load; and any faults associated with the vehicle. Data gathered from the one or more fuel injectors, for example, may be able to identify poor or contaminated fuel because the fuel injectors will increase or decrease the amount of fuel delivered to compensate. This should be able to be used to identify use of use of Red diesel, high % bio diesel, or use of cooking oil such as rape seed oil. Data relating to one, some, or all of the above parameters may be gathered by the vehicle data gathering means 102 when it is connected to a vehicle diagnostics port.

In the case of data gathering relating to how much fuel the fuel injectors are delivery to the engine, this may include monitoring a fuel pump output with a fuel flow sensor, or monitoring a period of time corresponding to how long each fuel injector is delivering fuel to the engine. The amount of fuel delivered to the engine can be compared with a stored threshold level corresponding to a normal fuel usage. If the actual fuel used is more or less than the threshold level this may be an indication that the vehicle is running on Red diesel, or a high % of bio diesel, or cooking oil such as rape seed oil.

In some embodiments, the vehicle data may include information obtained from a level sensor within the fuel tank. The variation in the level of the fuel in the fuel tank can be used as part of the comparison to determine if there is an anomaly between the actual fuel used by the engine and the amount of fuel purchased using a fuel card.

The vehicle diagnostics system, preferably the EOBD and OBD also has a clock so that the time at which signals were generated can be determined. In some embodiments the EOBD has access to a clock that is available in a remote terminal unit (RTU).

In some embodiments, information in relation to one or more fuel pumps/injectors may be available as part of the vehicle data, preferably as part of the vehicle diagnostics/EOBD data. The injector opening timing information at known fuel pressures can be processed to determine the amount of fuel used, and subsequently the number of miles per gallon (mpg).

The vehicle data may provide information about how many times fuel has been injected into the cylinders of the engine, and the volume of fuel that has been injected each time, or a flow rate of fuel for each injection/intake. In this way the volume of fuel that has been used by the engine can be directly derived from the vehicle data, and can be used as a direct comparison with the volume of fuel that has been purchased with the fuel card.

In some embodiments the product of the speed of a fuel pump and the volume of fuel pumped/injected by the speed pump can be integrated over a given timeframe (from a start time to an end time) in order to obtain a value for the total volume of fuel that has passed through the pump in the timeframe. Expressed mathematically:

$$total\_volume \_of \_fuel = {\int }_{end\_time}^{start\_time} ( pump\_speed ⋆ volume ) d t$$

One, some, or all of the above parameters may be used as vehicle data to determine how much fuel the vehicle 100 has actually used, and in some embodiments, at what time/on what journey.

Using the vehicle data to determine how much fuel has been used can enable a more accurate determination/estimation of how much fuel has actually been used by the vehicle when compared with the prior art. Using the vehicle data in this way can account for the style with which a driver drives, which in turn effects the fuel consumption of the vehicle. For example, how aggressively the driver drives and how highly the engine is revved. Also, any long delays where the vehicle may be stationary in traffic can be taken into account when determining how much fuel the vehicle has used.

In one embodiment, the revolutions per minute (rpm) of the engine can be used to provide an estimate of how much fuel the engine has used. A correlation between the rpm of the engine and the amount of fuel that is used at those revolutions per minute may be known, and stored in a look-up table or database stored in computer memory 116. An example of a database showing a correlation between rpm and fuel usage is shown in FIG. 3. An average volume of fuel that is used by the engine in a specified amount of time, in this example an hour, is associated with a range of values for the rpm of the engine, and is stored in the database. In this example, the ranges of values are 0-1000 rpm, 1000-2000 rpm, 2000-3000 rpm and 3000-4000 rpm. It will be appreciated that any other ranges of values could be used, and that with more ranges with a smaller span a more accurate estimate of fuel consumption can be obtained. A compromise between the amount of computer memory required to store the database/s, and the accuracy of the estimate of fuel consumption can be made.

The amount of time that the engine is within a range of rpm values can be recorded, and when it is decided to calculate the estimate for how much fuel has been consumed by the vehicle, the amount of time within each range is multiplied by the average fuel usage per time for that range of values as defined by the database of FIG. 3. The fuel usage for each range of rpm values can then be summed in order to provide the total fuel usage for a known period/journey.

In other embodiments, the fuel usage at discrete, spaced apart, values of the vehicle data parameter may be stored in computer memory, and it may be necessary for the computer processor to run a computer algorithm to interpolate the spaced apart fuel usage values in order to provide fuel usage data at values intermediate of the discreet known values if required.

It will be appreciated that there may be different databases associated with different vehicles stored in computer memory, and that an identifier of the vehicle can be used to determine which of the databases should be used.

In other embodiments, a table showing the average amount of fuel that is used when a vehicle is driven at a certain speed can be stored in computer memory 116. A representation of the speed that the vehicle has been driven at, as determined by the vehicle data gathering means 102, can be compared with a suitable table stored in computer memory 116 in order to determine how much fuel has been used by the vehicle 100.

It will be appreciated that any of the vehicle parameters discussed above can be used in combination with a database/look-up table defining fuel usage at certain values (or ranges of values) of that parameter in a similar way in order to determine how much fuel a vehicle has actually used.

It will also be appreciated that more than one of the parameters could be used in combination to determine how much fuel the engine has used. For example, the rpm could be used in combination with the gear ratio of the gear in which the engine is running to provide a more accurate estimate of the fuel consumption of the vehicle. In other embodiments, more than one of the vehicle parameters can be used independently to provide a number of fuel usage estimates obtained from different vehicle parameters. An average value of the total fuel consumption as determined independently by each of the different vehicle parameters can then be calculated.

In some embodiments, the average value of the vehicle data parameter, for example the speed or rpm, over an entire journey may be used to determine how much fuel has been used—the fuel consumption associated with the average value of the vehicle data parameter may be multiplied by the total journey time to generate the estimate for the fuel consumption based upon the vehicle data.

In other embodiments the journey may be broken down into time segments, for example 1 hour time segments, or 30 minute, or 10 minute, or 5 minute, or 1 minute time segments, and the amount of fuel that has been used may be calculated for each of the time segments, and then added together at the end of a journey.

It will be appreciated that a journey could be defined as the driving between consecutive visits to a refuelling station, and particularly visits where the fuel card is used. Alternatively, a journey could be defined by the driver of the vehicle by identifying the start and end of a journey that is for business use, therefore defining a journey for which the fuel card data is applicable. In a further embodiment still, a journey may be defined as the route driven from when an engine is turned on until the engine is next turned off, although in some embodiments if the engine is turned off for a short period of time, for example if the engine is stalled, or if the vehicle is refuelled, this will not be identified as the end of a journey.

In some embodiments, information relating to the time and/or date of a journey may provide an indication of an anomaly. For example, a journey late at night or on a non-working day, for example on a weekend or a bank-holiday, that is claimed as being for business purposes may be indicative of an anomaly if a driver does not drive for business purposes at those times/on those days. As another example, a journey that indicates that fuel is claimed as being for business purposes whilst the driver is on annual leave may be indicative of an anomaly, and possibly fraudulent use of a fuel card.

The estimate as to how much fuel has been used by the engine as determined by the vehicle data is compared with the amount of fuel that has been purchased with a fuel card by computer processor 114. As discussed above, the amount of fuel that has been purchased with the fuel card is already stored in computer memory 116 and is therefore available to computer processor 114.

An anomaly is identified by the computer processor 114 if a comparison between the vehicle data or a representation of the vehicle data, and the fuel card usage data or a representation of the fuel card usage data, does not satisfy a rule, or set of rules. The set of rules may define scenarios/situations that may be associated with fuel card fraud, or may compromise the security of the fuel card.

In particular embodiments, an anomaly is generated if a difference between the amount of fuel used as determined from the vehicle data, and the amount of fuel used as determined from the fuel card data, is greater than a certain threshold, and an indicator/alert is generated if an anomaly is determined. This may provide an indication that a driver is claiming expenses for more business fuel than he has actually used. In some embodiments the rule, or set of rules, may comprise a conversion of the format of one, or both, of the vehicle data and fuel card usage data in order to compare the vehicle data with the fuel card usage data.

The size of the difference between the compared values may be considered as an absolute value, or alternatively as a percentage of one of the values of fuel usage. Using a percentage difference can enable the anomaly to more accurately reflect any differences, without being effected by the total amount of fuel used and/or the length of the journey. In some embodiments anomalies may have one of a plurality of severities depending upon the size of the difference between the fuel usage estimates. Examples of differing severities may include minor, medium and severe for increasing sizes of differences between the compared values. There may be any number of severities in other embodiments of the invention. A higher severity anomaly may be more likely to be related to fuel card fraud, or a breach of the security of the fuel card, than a lower severity anomaly.

In some embodiments, indication signals/alerts with different severities may be presented to different people. For example, a mild severity anomaly may be presented to the driver himself as a deterrent to committing any further fraud. A medium severity anomaly may be communicated to a manger/employer of the driver and optionally the driver himself. A high severity anomaly may be communicated to the police, or another law enforcement agency, and optionally a manager/employer of the driver, and optionally the driver himself. That is, a high severity alert may be reported directly to the police, whereas lesser severity alerts may be dealt with internally within the company that employs the driver.

In some embodiments, an alert that is generated when an anomaly is determined may be fed back to the appropriate person by a message popping up on his personal computer, or by receiving an email. Other examples of how the anomaly can be feedback to a person include sending an SMS message to a mobile telephone, sending a pre-recorded message to a telephone, which may or may not be a mobile telephone, etc.

In other embodiments, the estimate of the amount of fuel used as determined by both the vehicle data and the fuel card usage data can be expressed as ranges of values and an anomaly is generated when the two ranges do not overlap. This can enable tolerances in the available data to be accurately reflected, for example, depending upon which vehicle parameter is used, and the accuracy of the available correlation data.

In some embodiments, one of the vehicle data and the fuel card usage data can be expressed as a range of values, and the other (e.g. the fuel card usage data) as a single value. In such embodiments, an anomaly is generated if the single value does not lie within the range of the values.

In some embodiments, the alert may be included in a report that details the amount of fuel that the vehicle has actually used, and the amount of fuel that has been purchased with the fuel card for business purposes. The report may be generated periodically, and/or when an alert is generated.

As a worked example, fuel card usage data may show that 10 litres of fuel have been purchased with the fuel card. An analysis of the received engine rpm data may show that the average rpm of the corresponding journey is 2500 rpm, and that the journey lasted for 3 hours. The table shown in FIG. 3 shows that this data corresponds to 6 litres worth of fuel. That is three hours worth of driving in the range 2000-3000 rpm. Therefore, the fuel card usage data indicates fuel usage of 10 litres and the fuel usage as determined from the vehicle data indicates fuel usage of 6 litres.

The computer processor/memory has been programmed to define that a difference of more than 10% of the fuel card usage data compared with the fuel usage determined from the vehicle data generates a minor indicator, a difference of more than 20% generates a medium indicator, and a difference of more than 30% generates a severe indicator. It will be appreciated that these percentages and levels of the indicator are examples only. The actual percentages and levels of the indicator used in practice may ultimately be determined and programmed by the customer or user. The percentages and levels may also be allocated on an individual basis depending on the driving style of the user.

In this example, the difference between the fuel card usage data and the fuel usage data as determined from the vehicle data is 40% as a percentage of the fuel card usage data, and therefore a severe indicator is generated.

It will be appreciated that any fuel card transaction will be an electronic transaction and therefore the off-vehicle computer 110 can easily have access to the fuel card usage data by any conventional means. The off-vehicle computer 110 may be in electronic communication with a computer processor associated with the fuel card company via the internet, through use of the transceiver 112, or by any other means.

It will be appreciated that embodiments of the invention allow a reconciliation between the actual fuel that a vehicle consumes as determined from the vehicle data, and the amount of fuel which is allegedly being used for business use as determined from the use of the fuel card.

Using the vehicle data obtained from the vehicle data gathering means 102 with the fuel card data can enable information relating to drivers and vehicles to be better integrated into a business system—the information can be automatically electronically integrated into electronic business systems. Examples of business systems that could benefit from use of the comparison information of the present invention can include payroll systems, driver timesheets, expenses and benefits systems, taxation systems, insurance systems, monitoring the total driving hours of individual drivers, the completion of HM Revenues & Customs form P11D for expenses and benefits in the UK, monitoring of how much CO₂, or other pollutants, are produced, etc. Such information can be determined in an accurate way with the knowledge that the information is correct. This is because information such as mileage and CO₂ is the real world value and not an estimation or a close approximation.

In some embodiments, the invention can be used to verify information that has been obtained from a driver's log, or has been obtained by any other means.

Use of the present invention can improve the security of fuel card systems, and can greatly reduce the amount and degree of fuel card fraud. The comparison between the vehicle data and fuel card data can reduce the chances that a user can make a fraudulent claim for the VAT (or any other tax) back on any purchases that are not for fuel that is used for business purposes. Using the vehicle data can reduce the chances that a driver can fraudulently claim VAT back for fuel that is not used for business purposes, for example fuel that is used for personal/private use, fuel that is transferred from one vehicle to another, or purchases that are not even fuel, for example confectionary from a petrol station.

Additionally, or alternatively, use of the invention can greatly reduce administration overheads, including computer resources that are required, administration staff time, computational requirements of associated systems, turn-around time for expenses claims and insurance claims, etc.

In the embodiment of FIG. 1, the computer processor 114 in the off-vehicle computer 110 performs the comparison between the vehicle data and fuel card data. The computer processor 114 accesses computer memory 116 in order to obtain fixed information that is related to the vehicle data and/or fuel card data. It will be appreciated that by fixed information, it is meant information or data that is not related to specifics of the journey, as such. For example, how much fuel is consumed by an engine operating at a certain value of a vehicle parameter may be considered as fixed information that is stored in computer memory, but nonetheless can be updated if more accurate information is available, or if the information changes over time.

In some embodiments, an anomaly can be communicated to one or more interested parties when, or shortly after, the anomaly is determined. The interested party may be the driver himself, a manager of the driver, an employer of the driver, a law enforcements agency, or any other person. The anomaly is preferably communicated electronically, for example by email, by SMS text message to a mobile telephone, or by posting the information on a website to which the interested party has access—for example, the employer may be able to log onto a website to see if any of their employees have caused any anomalies to be generated.

Once the computer processor 114 has compared the vehicle data and the fuel card usage data, it may be arranged to generate a report based on that comparison data. In some embodiments, the report may be produced periodically, for example daily, once a week, once a month, or may be produced as and when a claim for reimbursement of VAT is made. The report may be produced periodically to coincide with when an employer runs their payroll, claims back their VAT, processes an employee's expenses claims, or may coincide with any other business procedure.

In other embodiments, the report may only be generated when an anomaly is determined by the comparison, for example if the fuel card data indicates that a disproportionate amount of fuel has been used compared to the actual usage of the vehicle as determined by the vehicle data gathering means 102.

In embodiments of the invention, the comparison and the generation of the report can be performed for an individual driver, for a fleet of drivers, for a user of a fuel card, for a user of a group of associated fuel cards, for an individual vehicle, for a company as a whole, or for any other convenient group of people/drivers/vehicles/companies.

The report may be an electronic computer file that may be displayed on a screen, alternatively, or additionally, the report may be a physical print-out of comparison data, with any anomalies highlighted. Also, any anomalies may be communicated to a supervisor and/or manager substantially as they occur. The supervisor/manager may be alerted by any known means, for example by receiving a text message on their mobile phone, by receiving an e-mail, etc.

In some embodiments, there is a computer memory in the vehicle 100, and vehicle data that has been gathered by the vehicle data gathering means 102 is stored in the computer memory in the vehicle before being transmitted by transceiver 104. This can allow vehicle data to be stored up and sent out in batches, which may make more efficient use of bandwidth associated with the wireless communication channel between the vehicle 100 and the off-vehicle computer 110.

If an occurrence of fuel card fraud is determined, the employer and/or the police may take further action. If it is appropriate for the matter to be dealt with internally within the company, the employer may automatically bill the employee for any fuel for which they have should not have claimed expenses for. For example, the cost of the fraudulently used fuel may be deducted from the employee's salary. Also, the employer's VAT claim form may be adjusted such that a claim for relief of VAT paid on the fraudulently purchased fuel is not made. In some embodiments, the employer may be fined, or otherwise penalised for using their fuel card incorrectly. This can be a deterrent to the driver.

A computer processor associated with the employer, which is preferably the computer processor that performs the comparison between the vehicle data and the fuel card usage data, may be arranged to automatically bill an employee who incorrectly uses their fuel card to purchase fuel to which they are not entitled to claim expenses for. Preferably, the computer processor also automatically amends/completes the employer's tax form.

The fuel card may operate as a known credit card which is billed on a periodic basis e.g. monthly, or it may be a pre-paid credit card. Such a pre-paid credit card has a fixed amount of money that is put onto the card e.g. £100, which is used to pay for fuel at a filling station when the fuel is put into the vehicle. The pre-paid credit card/fuel card may be arranged so that money is only put onto the card on demand such as when fuel is required to be purchased. This has the advantage that if the fuel card is stolen is has no value to a thief. This arrangement also allows a business to limit the amount of cash that it has on pre-paid cards that could otherwise be in a bank account earning interest. The pre-paid credit card/fuel card and associated system acts as an acquirer of data and issuer of an authorisation to purchase fuel. Such an arrangement avoids the monthly billing associated with known credit cards and allows data feedback on fuel purchase and/or fuel usage to be substantially in real time. Reducing the amount of time between filling the vehicle with fuel, purchasing the fuel and data feedback in this manner may further assist in reducing fraud.

Whereas traditional fuel cards are generally only available to very large companies, a pre-paid credit card can be made available to anyone who wants one. The rules governing who may have a pre-paid credit card may not be as strict because the company or individual is required to charge the pre-paid credit card with credit before it can be used to pay for fuel.

In some embodiments a company may put credit onto a pre-paid fuel card account for a person. The company/fleet managers would know that there was a specific amount of fuel in the vehicle (e.g. 13 litres of diesel in a car) and that the person had bought a specific volume of fuel (e.g. 30 litres of diesel). They can then determine that there should be a calculated amount of fuel in the vehicle (e.g. 43 litres of diesel). They can know this very quickly, in comparison with waiting for monthly credit card statements or monthly fuel card statements—within seconds, minutes, or tens of minutes of the extra fuel being purchased. The fleet manager/company can then compare the fuel consumption of the vehicle for additional mileage driven by the vehicle with the predicted fuel consumption based on vehicle metrics (speed, weight of vehicle, gear selected, rpm, etc.). If there is a discrepancy the fleet manager/company can identify a potential fraud and can take remedial action promptly. For example, if the fuel card is used (e.g. again) to put more fuel than the system thinks the vehicle's fuel tank can accommodate, bearing in mind the fuel already in the fuel tank as measured by sensors and/or as predicted by usage of the vehicle since refuelling, then this may indicate that the card is being used to fuel a different vehicle, or that fuel is being siphoned out of the vehicle for use in another vehicle. If the system/fleet manager can get that indication within minutes/hours/the same day or next day or two, of the suspicious event, he can take remedial action much faster than waiting for an end of the month analysis. Sometimes, a quiet word with the driver after the first event can prevent extra improper usage, and eliminating a problem quickly whilst it is a small problem may make it possible to have greater flexibility in how the matter is dealt with, compared with finding out about it only after a lot of fuel has been misappropriated.

One server may contain fuel purchase details, and another telemetric data on the vehicle usage, and information from both servers may be necessary to implement the invention.

The vehicle telemetric server and/or the fuel card server may be a special server networked to a network and providing special functionality (the anti-fraud functionality).

In some circumstances, the driver need not go into the garage/petrol station shop to pay for fuel: there may be a vehicle identification system that identifies the vehicle (e.g. cameras to look at the number plate and OCR technology), and the cost of the fuel may be debited from the pre-paid (or otherwise) card account electronically.

FIG. 2 shows an alternative system for comparing vehicle data with fuel card usage data and generating an indicator if there is an anomaly between the vehicle data and fuel card usage data according to the present invention. Corresponding reference numbers in the 200 series are used to identify similar features in FIG. 2 to those identified in the 100 series in FIG. 1.

In addition to the features of FIG. 1, the car 200 in FIG. 2 also comprises an in-vehicle computer processor 206 and computer memory 208. In this embodiment, the computer processing that is required to perform the present invention can be split between the computer processor 114 in the off-vehicle computer 210 and the computer processor 206 in the car 200, and the fixed information, or some of the fixed information (for example in relation to that specific vehicle), can be duplicated in the on-vehicle computer memory 208. This can enable the system to run more efficiently, as the computer processing and accessing of computer memory can be performed at a preferred location. For example, if the off-vehicle computer processor 214 does not have any, or much, free processing capacity, the computer processing can be performed by the on-vehicle computer processor 206, and vice versa.

In other embodiments, all of the computer processing can be performed by the computer processor 206 located within the car 200, and all of the fixed information can be stored in computer memory 208. In such embodiments, an off-vehicle computer 210 is not required at all, and the vehicle 200 can operate as a stand-alone device 200. Information relating to the fuel card usage can be received by the transceiver 204 directly from the electronic point of sale, in order that the on-vehicle processor 206 has access to both the vehicle data and the fuel card usage data. This can enable the on-vehicle computer processor 206 to perform the necessary processing operations on the available data in order to determine if there is an anomaly between the vehicle data and the fuel card usage data.

This embodiment may be particularly useful when fuel usage is being considered for only one vehicle, and not a fleet of vehicles.

FIG. 4 shows an alternative system according to the present invention. Corresponding reference numbers in the 300 series are used to identify similar features in FIG. 4 to those identified in the 200 series in FIG. 2.

In addition to the features of FIG. 2, the system also comprises a fuel pump 320 (shown in FIG. 4). The fuel pump 320 comprises a transceiver 322 that is arranged to be in electronic communication with the car 300 and the off-vehicle computer 310 and also comprises a computer processor 324. In this embodiment, the fuel pump 320 is the electronic point of sale where fuel is purchased with the fuel card.

In this embodiment, there is no need for a user to carry a physical fuel card. This embodiment of the invention can be considered as utilising a “virtual fuel card”, as described below.

When the vehicle 300 pulls up to a fuel pump 320 in a refuelling station, the transceiver 304 within the vehicle transmits an identifier of the vehicle and/or driver of the vehicle to the transceiver 322 in the fuel pump 320. The identifier may be a vehicle identification number (VIN), which may be used by a computer processor to retrieve corresponding billing information. Alternatively, or additionally, the identifier may include billing information for the driver or an employer of the driver, such as an account number for the driver/vehicle, an invoice-to address, the name of the driver, the name of an employer of the driver, the registration number of the vehicle, a vehicle identification number (VIN), and any further information that can enable an invoice to be produced for the subsequent fuel dispensed from the fuel pump 320. In some embodiments, the identifier may include the same information that is encoded onto a known fuel card.

In other embodiments, instead of the vehicle 300 actively transmitting the identifier to the fuel pump 320, the fuel pump 320 itself may be arranged to extract an identifier from the vehicle 300 itself. As an example, the fuel pump 320 may be connected to a camera that is arranged to capture an image of the vehicle's registration plate. The image of the registration plate may then have optical character recognition (OCR) software performed on it to convert the image into a string of text that identifies the vehicle registration number. The vehicle registration number can then be used to obtain billing information for the user, for example by looking up the registration number in a database. An invoice for the fuel can then be generated and sent out at an appropriate time. In other embodiments any other data gathering means may be used to extract an identifier from a vehicle.

Returning to the embodiment of FIG. 4, the fuel pump 320, and more specifically a computer processor 324 within the fuel pump 320, knows the identity of the vehicle/driver using the fuel pump and the billing information relating to that driver/vehicle from the identifier received from the vehicle, and also knows how much fuel has been dispensed into the vehicle 300 by the fuel pump 320. Therefore, a bill can be automatically generated for the fuel purchased. Preferably all a driver of a vehicle needs to do is to drive up to the fuel pump 320, dispense fuel into their vehicle, and then drive away. The bill for the fuel dispensed is generated automatically by a computer processor in the fuel pump 320, or by a computer processor in electronic communication with the fuel pump 320, and sent directly to the billing address, or added to a cumulative bill so that it can be sent out in the future.

Using the identifier such as the VIN may also avoid fraud where the driver illegally changes the number plate on the vehicle for the purposes of refuelling to avoid a camera at the petrol station, and therefore payment for the fuel.

In some embodiments, vehicle data obtained from a fuel level sensor within the fuel tank of the vehicle can be analysed by the on-vehicle processor 306 (or any other computer processor) to verify the amount of fuel that has been dispensed into the car 300.

In some embodiments, the vehicle data obtained from a fuel level sensor can be used to check that an increase in the level of the fuel in the fuel tank after refuelling corresponds to the amount of fuel that has allegedly been put into that car as determined from the fuel card usage data in relation to the corresponding fuel purchase transaction. These embodiments can be particularly useful for determining an anomaly that is associated with a scenario where a user claims to be using fuel purchased for a certain vehicle, but is actually putting fuel into a neighbouring vehicle, or into a reservoir/canister within their boot, for example.

If such an anomaly is determined, an alert may be generated, which may be sent to a manager of the driver. Further, an alert may be generated to the driver himself, and may be shown on a display within the vehicle, for example on the dashboard of the vehicle, and may show a message that tells the driver that he has been caught. This may act as a deterrent to the driver performing fuel card fraud again.

In some embodiments, the determination of an anomaly whilst a driver is in a refuelling station, or at any other known location, may cause a camera to take a photograph of the driver who has used the fuel card. Cameras that are already present in the fuel refilling station may be used, alternatively, there may be one or more cameras associated with the vehicle, and these may be used to capture an image of the driver. These embodiments may be useful if it is suspected that a driver's partner/husband/wife has been using the fuel card fraudulently.

The amount of fuel purchased using the “virtual fuel card” can be used as fuel card usage data in any of the embodiments discussed in this patent application in order to determine if there is an anomaly between fuel card usage data and vehicle data.

In embodiments where the fuel card usage data is used to determine whether or not there is an anomaly between fuel card usage data and vehicle data, the physical locations at which fuel was purchased using the fuel card can be used as a further check as to how much fuel has been used by the vehicle. For example, refuelling stations may be geo-coded and the geographical information about where a vehicle was refuelled can be used to verify how far, and where, a vehicle has been driven. Also, if a vehicle has been refuelled at a location that is not in keeping with the supposed location of the vehicle, an anomaly may be determined. The vehicle data and/or the fuel card usage data may be time stamped, and this may prove useful when determining if the supposed location of the vehicle is not in keeping with where the vehicle has been refuelled. For example, if the vehicle is allegedly refuelled at locations that are geographically far apart, this may be an indication that the same fuel card is being used fraudulently by more than one person. The refuelling acts that caused an anomaly to be determined can be analysed in more detail if deemed necessary.

Also, use of the virtual fuel card can reduce the possibility that there are any discrepancies between the amount of fuel that was allegedly purchased using a fuel card, and the corresponding amount of money spent on the fuel card. It may be difficult or impossible for a driver to purchase items that are not fuel, for example chocolates and drinks, with the virtual fuel card.

In an alternative embodiment of the virtual fuel card concept the electronic data from the car becomes the data for a fuel card when the fuel is purchased using a normal credit card, such as a business credit card. In this embodiment a record is made of how much fuel was bought and where it was bought against a registration number of the vehicle, and optionally a stated mileage from the driver of the vehicle. The advantages of this arrangement are that the normal credit card is electronically related to the data from the vehicle so that it is not necessary to have a separate fuel card. In this embodiment all that is required is an algorithm to match the data from the vehicle to the normal credit card. In addition, if the vehicle if provided with a GPS receiver it is possible to match the location of the vehicle against a petrol station database so that the petrol station is further verified.

In alternative embodiments, a physical fuel card may still be used, and the fuel pump 320 may be arranged to receive an electronically readable fuel card in order to purchase fuel. Nonetheless, fuel card usage data is still obtained for use with embodiments of the invention.

The situation may arise when there are multiple drivers of the same vehicle at different times where it may be very difficult to compare fuel data against a particular driver. This is because the fuel is not necessarily recorded for each change of driver. To deal with this situation a driver ID device may be included on the vehicle to identify the driver at a particular time and to monitor fuel usage data for that driver. Alternatively knowledge of who is driving the vehicle at any given time can be used to allocate how much fuel was used by a particular driver.

FIG. 5 shows graphically the steps performed by a method for generating an alert/indicator according to an embodiment of the present invention. Vehicle data and fuel card usage data are received at steps 402 and 404 respectively. Preferably, the data is received over a wireless communication channel from one or more remote data gathering means. In alternative embodiments, the data could be received over a hard-wired link from a data gatherer in the same physical location as the location at which it is received. It will be appreciated that it does not matter in which order the vehicle data and fuel card usage data are received.

The vehicle data is then compared with the fuel card usage data according to a set of rules at step 406. The set of rules define an anomaly in terms of the comparison between the vehicle data and fuel card usage data. The set of rules may define a threshold for the difference between the vehicle data and the fuel card usage data that characterizes an anomaly. The set of rules may also include an algorithm/conversion that may need to be performed on the vehicle data and/or fuel card usage data in order that the data can be compared. The conversion may ensure that each of the vehicle data and the fuel card usage data has a representation that can be compared with the other of the vehicle data and fuel card usage data according to the set of rules: the format/units of the vehicle data and fuel card usage data after conversion may be the same. For example, the vehicle data may be converted into a volume of fuel that has been used according to the corresponding vehicle data such that it can be compared directly with the fuel card usage data.

After the vehicle data has been compared with the fuel card usage data, the result is analysed to determine whether or not there is an anomaly between the vehicle data and the fuel card data at step 408. For example, does the difference between the fuel card usage data and vehicle data exceed a threshold?

If it is determined that there is an anomaly at step 408, an indicator/alert is generated at step 410. The alert may then be communicated to an appropriate person, for example a fleet manager, a director of the company that employs the driver, a manager of the fuel card company, a government official, or a law enforcement agency. Of course, in some embodiments the alert may be communicated to more than one of the above people, or any other appropriate person. The alert may be communicated in any appropriate way, for example by email, by text message, by automated telephone message, by activating a pager, etc. Preferably, the alert is communicated automatically upon determination of an anomaly without requiring human intervention.

If it is determined at step 408 that there is not an anomaly, the method ends at step 412.

A non-limiting example set of rules that may be applied to the vehicle data and/or fuel card usage data now follows by way of illustration.

### Example Set of Rules:

### Rules for Converting the Format of Vehicle Data:

If vehicle data comprises rpm data: convert rpm data to fuel volume used with Database A.
If vehicle data comprises speed data and gear ratio data: convert speed and gear ratio data to fuel volume used with Database B.

### Generate an Anomaly if:

the fuel usage as determined from the vehicle data differs from the fuel usage as determined from the fuel card usage data by more than 5% of the fuel usage as determined from the vehicle data; or
the fuel usage as determined from the fuel card usage data differs from the fuel usage as determined from the vehicle data by more than 5% of the fuel usage as determined from the fuel card usage data; or
the fuel usage as determined from the fuel card usage data differs from the fuel usage as determined from the vehicle data by more than 5 litres; or
the vehicle data obtained from a fuel level sensor in the fuel tank shows that the fuel level within the tank has not increased by a volume of fuel as indicated by corresponding fuel card usage data when a vehicle is refuelled; or
the vehicle data obtained from a fuel level sensor in the fuel tank shows that the fuel level has dropped whilst the engine has been switched off; or
the vehicle was used allegedly for business purposes on a non-working day; or
the vehicle was used allegedly for business purposes when the driver was supposedly on annual leave.

It will be appreciated that the method illustrated in FIG. 5 may be run substantially in real-time, periodically, or upon the occurrence of a event. Examples of an event that may trigger the method illustrated in FIG. 5 include the end of a journey, a visit to a refuelling station, use of the fuel card, and a driver/manager/user triggered event for example when performing payroll or when claiming VAT back from the government.

FIG. 6 shows graphically the steps performed by a method for generating an alert according to another embodiment of the present invention. Vehicle data and fuel card usage data are received at steps 502 and 504 respectively in the same way as discussed in relation to FIG. 5.

At step 506, the vehicle data is converted from a parameter that describes the performance of the engine of the vehicle into a different format that can be compared directly with the fuel card usage data. In this embodiment the different format is the volume of fuel that the engine has consumed, in alternative embodiments the different format may be the cost of the volume of fuel that the vehicle has consumed, for example.

In other embodiments, the fuel card usage data may be converted into a different format so that it can be compared directly with the format of the vehicle data.

In further embodiments still, both of the vehicle data and the fuel card usage data may be converted into a different, common format, in order that the converted vehicle data may be directly compared with the converted fuel card usage data.

At step 508, a range of fuel consumption values is determined for both the fuel card usage data and the converted vehicle data. By determining a range of associated fuel consumption values, tolerances in the recording of the fuel card usage data, recording of the vehicle data, and converting of the vehicle data can be accounted for. Different tolerances, and therefore ranges with different sizes, may be used when different vehicle data parameters are considered—for example, some vehicle data parameters may be more accurate than others.

Also, different sized ranges may be used depending upon the accuracy of the conversion from the vehicle data to the associated fuel consumption data, and how the vehicle data is converted. For example, if a lot of averaging is required to convert the vehicle data into fuel consumption data, a large range may be used for the converted data.

The ranges of fuel consumption associated with the vehicle data and fuel card usage data are compared at step 510. If the ranges do not overlap an anomaly is determined at step 512, and an alert is generated at step 514. If the ranges do overlap, no anomaly is determined at step 512, and the method ends at step 516.

FIG. 7 shows graphically the steps performed when generating an alert according to an embodiment of the present invention. At step 602, the engine of a vehicle is tuned off. This may be to enable a vehicle to be refuelled, when a driver has completed a journey, or simply so that the driver can have a break from driving, for example.

The level of fuel in the fuel tank is monitored at step 604. This may comprise performing a further interrogation of vehicle data, for example vehicle diagnostics/EOBD data, after the engine has been turned off, or may comprise storing in memory the last value for fuel level that was recorded before the engine was turned off. The level of fuel recorded at this stage may be referred to as the first fuel level.

At step 606, the engine is turned on. This may represent the end of a refuelling operation, the start of a new journey, or the end of a break in an existing journey, as examples. The level of fuel in the fuel tank is monitored again at step 608 after the engine is turned on. The level of fuel monitored at step 608 may be referred to as the second fuel level.

The first and second levels of fuel are compared at step 610, and an alert is generated if there is a discrepancy between the two levels of fuel.

If the second level of fuel is significantly less than the first level of fuel, this may signify a discrepancy between the two levels of fuel, as the fuel level has gone down when the engine has not been running. This may provide an indication that fuel has been siphoned out of the vehicle whilst the engine has been off.

Alternatively, or additionally, if the second level of fuel is significantly more than the first level of fuel, this may indicate that the vehicle has been refuelled and may cause a further check to be performed to determine if the level of the fuel has increased by an unexpected amount.

If it is determined that the vehicle has been refuelled, the amount of extra fuel that has really been added to the fuel tank can be determined from the difference between the first and second levels of fuel. In embodiments where the level of fuel represents the depth of fuel in the fuel tank, the cross-sectional area of the fuel tank may be known in order to convert the depth of fuel in the fuel tank into volume of fuel within the fuel tank.

The volume of fuel that has been added to the fuel tank as determined from the first and second fuel levels, can then be compared with the volume of fuel that has been purchased as determined from fuel card usage data, as discussed above. A discrepancy may be determined if the two volumes are not the same, or are not sufficiently close as determined by a rule/threshold, for example. Such a discrepancy may indicate that a user has used a fuel card to dispense fuel that has not been put into their vehicle. For example, the user may have dispensed fuel into a fuel canister, which they may, or may not put in their boot to take away for use with a different vehicle.

FIG. 8 shows an alternative system according to an embodiment of the present invention. Corresponding reference numbers in the 800 series are used to identify similar features in FIG. 8 to those identified in the 300 series in FIG. 4.

In addition to the features of FIG. 4, the system of FIG. 8 also comprises a fuel card 830 (shown in FIG. 8), a card database 840, and a vehicle telematics database 850. The fuel card may be a conventional fuel card or may be a prepaid fuel card which is authorised for use to buy fuel up to a predetermined amount as described below, for example £100. The card database 840 is in communication with the off-vehicle computer 810 and contains information relating to a plurality of fuel cards 830 and may contain information relating to how much fuel they have been authorised to buy. The off-vehicle computer 810 may be a special server arranged to perform the operations described below. The amount of money registered against each fuel card in the card database 840 may be a code, such as a security code, that relates to an amount of money.

The telematics database 850 contains information relating to individual cars 800 from the vehicle data gathering means 802. The telematics database 850 is in communication with the off-vehicle computer 810. Alternatively the vehicle telematics database 850 is provided in another special server which is in communication with the off-vehicle computer 810. In this embodiment, the fuel pump 820 is the electronic point of sale where fuel is purchased with the fuel card 830, but it will be appreciated that the point of sale may be a kiosk near to the fuel pump 820.

When the vehicle 800 pulls up to a fuel pump 820 in a refuelling station, the transceiver 804 within the vehicle transmits an identifier of the vehicle and/or driver of the vehicle to the transceiver 822 in the fuel pump 820. The transceiver 804 may transmit this information when the vehicle is at a predetermine distance to the transceiver 822 of the fuel pump 820. The identifier may be a vehicle identification number (VIN), which may be used by a computer processor to retrieve corresponding billing information or vehicle telematics information. Alternatively, or additionally, the identifier may include billing information for the driver or an employer of the driver, such as an account number for the driver/vehicle, an invoice-to address, the name of the driver, the name of an employer of the driver, the registration number of the vehicle, a vehicle identification number (VIN), and any further information that can enable an invoice to be produced for the subsequent fuel dispensed from the fuel pump 820. The identifier may include the distance traveled by the vehicle. In some embodiments, the identifier may include the same information that is encoded onto the fuel card 830 so that it can be further verified that the card 830 and the vehicle 800 are for use by the same person.

The fuel pump 820 is arranged to receive the fuel card 830 and to read electronic data that may be stored on it in order to purchase fuel. In other embodiments, instead of the vehicle 800 actively transmitting the identifier to the fuel pump 820, the fuel pump 820 itself may be arranged to extract an identifier from the vehicle 800. As an example, the fuel pump 820 may be connected to a camera that is arranged to capture an image of the vehicle's registration plate. The image of the registration plate may then have optical character recognition (OCR) software performed on it to convert the image into a string of text that identifies the vehicle registration number. In other embodiments any other data gathering means may be used to extract an identifier from a vehicle.

Returning to the embodiment of FIG. 8, the fuel pump 820, and more specifically a computer processor 824 within the fuel pump 820, knows the identity of the vehicle/driver using the fuel pump, and also knows how much fuel has been authorised to be dispensed into the vehicle 800 by the fuel pump 820. Therefore, when a user inserts the card 830 into the fuel pump 820 to pay for the fuel the card database 840 can be checked to see if there are sufficient funds to pay for the fuel or if there is sufficient authorisation to pay for the fuel. This step may be performed before the fuel has been dispensed so that if there are insufficient funds an alarm can be indicated and the fuel pump can be switched off. This may be achieved by a fuel station forecourt attendant or by an automatic intervention by the processor 824. The cost of the fuel is debited from the card database 840.

It will be appreciated that the amount of fuel purchased and the money debited from the prepaid credit card database 840 can be cross referenced with the vehicle telematic database 850 to determine whether fraud has taken place. If the vehicle telematics database 850 indicates that the fuel tank is full it may be possible to determine whether fraud is about to take place. For example, vehicle data obtained from a fuel level sensor within the fuel tank of the vehicle 800 can be analysed by the on-vehicle processor 806 (or any other computer processor) to verify the amount of fuel that has been dispensed into the car 800. By cross referencing the prepaid credit card database 840 and the vehicle telematic database 850 substantially at the same time as the fuel put into the car 800 an indication of an anomaly can be determined. In the case of a pre-paid credit card this anomaly may be determined earlier than if a normal credit card had been used because such a normal credit/charge card if typically only billed on a monthly basis. The use of a prepaid credit card allows fraud to be detected and remedial action to be put in place much soon i.e. up to one month sooner which equates with the reduction in the time for paying for the fuel. This embodiment can be particularly useful for determining an anomaly where a user claims to be using fuel purchased for a certain vehicle, but is actually putting fuel into a neighbouring vehicle, or into a reservoir/canister within their boot, for example.

Data on how the vehicle is performing may also be useful in determining whether there is an anomaly between the fuel used by the vehicle, and the fuel put into the vehicle fuel tank. For example, if the vehicle is not operating efficiently the fuel economy may worsen which might generate a false anomaly. This may happen if, for example, the timing of engine fuel injectors moves away from an optimum timing. Vehicle data such as data on injector timing, or other engine/vehicle operating parameters may be fed into the off-vehicle computer 810 to assist with determining if there is an anomaly between fuel card usage data and the vehicle data.

In a further arrangement to improve fraud protection and avoid fuel theft the fuel card may be tied to a particular fuel vender such as a chain of forecourt fuel garages. Any attempt to use the fuel card at a non authorised garage would not work and the user would not be able to purchase fuel using the card. Alternatively, the fuel card may be tied to a particular type of product, such as Diesel. This may also limit the possibility for fraud of fuel theft. Such tying in of the fuel card to a particular vender or product can be achieved by embedding data relating to a fuel vender or product in the chip 860 of the card, or in the off-vehicle computer 810.

FIG. 8 also shows that the fuel card 830 may have a Radio Frequency Identification Chip (RFID) 860 and RFID antenna 870. The RFID chip 860 contains identification data relating to the driver of the vehicle 800. The processor 806 is also shown connected to a switch 880 of the vehicle 800 which is operable to immobilise or mobile it by, for example, switching off a fuel ignition system of the vehicle under the control of the processor 806.

In operation the system of FIG. 8 knows the identity of the driver from the identification data on the identification chip 860, the fuel data from the fuel pump 820 and/or the off vehicle computer 810, the vehicle identification and mileage, any other vehicle data from the vehicle data gathering means 802, and data sent back to the vehicle 800 in real-time from the off-vehicle computer 810. This information can be used to immobilise or mobilise the vehicle 800 by activating the switch 880 if the driver is not the authorised driver (provided by identification information on the identification chip 860) or if an anomaly is detected which may indicate that fraud is taking place or about to take place. In this embodiment the fuel card 830 provides the authorisation to purchase fuel, and the authorisation to drive the vehicle 800. The identity of the driver may be provided in the form of a code which is programmed into the RFID chip 860. The code is passed on to the processor 806 via the RFID antenna 870 which operates the switch 880 if the code is correct in order to mobilise the vehicle 800.

Using a fuel card containing the driver identification allows the possibility to determine a driving style, or use profile, of the vehicle and to control the vehicle in response to the use profile. The use profile can be compared with a previous driving style or use profile for the driver to determine whether the driver is driving erratically, or differently. Such erratic driving may be due to tiredness, or being under the influence of alcohol or other drugs. A different driving style may be due to theft of the fuel card and hence the vehicle being driven by a different person. If an anomaly or difference is determining between how the vehicle is being driven when compared to the previous use profile, the vehicle can be controlled from the remote computer 810 to immobilise it. Alternatively, the vehicle may be controlled to limit the top speed or acceleration.

It will be appreciated that the system of FIG. 8 may also be used to inhibit the wrong type of fuel from being put into the vehicle 800. Data relating to the fuel type of the vehicle 800 may be stored on the chip 860 of fuel card 830 or in the memory 816 of the off-vehicle computer 810. This data can be used to authorise dispensing of fuel from the fuel pump 820 before fuel is attempted to be put into the vehicle. The chip 860 may also be used to store information such as the size of fuel tank. Should a driver dispense a quantity of fuel which is more than the fuel tank capacity, this is an indication of an anomaly between the vehicle data and the card usage data and that fraud may have taken place.

Since the fuel card 830 of FIG. 8 contains data relating to an identity of a person, the card may further be used as a general security card for access control. Such access control may be for example to gain access to a building, or a particular room in a building.

In another embodiment the credit card or pre-paid credit card 830 of FIG. 8 is arranged to be able to pay for goods, services or road charges such as a road toll charge or a traffic congestion charge, for example the London traffic congestion charge. Known Electronic Point of Sale (EPOS) systems are arranged to record data about transactions which take place. For example, level 2 EPOS data may include information about the fuel type (e.g. Diesel) and a fuel vendor (e.g. Tesco Supermarket), and level 3 EPOS data may include information about the fuel type, the amount of fuel sold, the amount of VAT paid, the person buying the fuel and the vehicle registration. Current EPOS systems may also record an Association for Payment Clearing Services (APACS) code that identify particular categories of goods. For example, one code may identify fuel, and another code may identify confectionary. In this embodiment pre-selected APACS codes are linked in the memory 808 and/or 816 with the card 830 to allow certain goods such as fuel, or confectionary, or vehicle maintenance parts to be purchased. In this way the card 830 can only be used to purchase particular types of goods such as fuel or confectionary. Vehicle maintenance parts may include a windscreen, an exhaust, or a tyre which may be needed to keep the vehicle in a drivable condition. This embodiment may be particularly useful if the vehicle has broken down and requires parts to be fitted by a roadside recovery organisation such as the AA (Automobile Association) or RAC (Royal Automobile Club). These parts can be paid for using the card 830 if necessary.

When the card 830 is used to pay for a road charge such as a congestion charge or a road toll charge, the vehicle is firstly identified by a charging system issuing the charge. This may be performed by either optical character recognition of a vehicle registration plate in a known manner, or by transmitting a vehicle identity from the transceiver 804 of the vehicle 800 according to the embodiment of FIG. 8. The card 830 is authorised for paying road charges via an APACS code stored in the memory 808 and/or 816 so that the charge can be paid directly to the charging system. This embodiment has the advantage that the road charge is paid automatically without the need for the driver to leave the vehicle to make the payment or interact with the charging system. Such a way of paying a road charge would allow the vehicle 800 to pass onto a toll road, or enter a congestion charge zone without requiring to stop and wait for payment to be made. It is also envisaged that the card 830 can be used in a similar manner to pay for vehicle insurance costs, or pay a charge due to CO₂ produced by the vehicle.

One of the advantages of the card being able to pay for things when the vehicle is travelling is that issues of taxation, for example due to the vehicle crossing country boarders, are handled at a remote location. Handling of tax matter can therefore be automated corresponding to which tax laws are applicable at the location of the vehicle. The driver would not have to worry about taxes regarding, for example, what constitutes a benefit in kind, or a CO₂ charge in a particular country. In this way the card can be used to automate the payment of tax. This may be particularly useful if there are a fleet of vehicles under the management of one company or organisation that pays tax.

In a further embodiment the card 830 may be used with a known mobile phone payment system such as M-PAY. In this embodiment the card 830 includes a Subscribed Identity Module (SIM) card which links the card to a mobile phone account. This allows items such as goods, services or charges to be paid for directly from the mobile phone account. It will be appreciate that payments can be made using the card 830 when it is not physically connected to the processor 806 and not physically located in the vehicle 800.

The above-described card has functionality as a fuel card, a payment card to pay for goods, services, road charges or vehicle maintenance items, or a card to pay for insurance costs or CO₂ usage costs. Such a card has the advantage of being a very convenient and flexible payment tool. For some of these transactions the driver of the vehicle is required to be present e.g. buying confectionary at a fuel filling station where the driver may be required to type in a card pin number. Such a payment when the driver is present is known as Static Data Authorisation (SDA). Alternatively, for certain other transactions the driver is not required to be present e.g. paying for a CO₂ charge in one country from another country. Such a payment when the driver is not present is known as Dynamic Data Authorisation (DDA). DDA is safer for the finance industry because usually the transaction includes an anti fraud insurance charge which is passed on to the buyer. If fraud does take place using DDA it is possible to track the chain of data to find out which seller in the selling chain was responsible for it. The fraud is charged to the organisation/person at fault. With DDA there is a delay in paying the charge, whereas with SDA payment is made substantially in real time. It will be appreciated that certain transactions using the card may use DDA which has the added benefit of providing an insurance against fraud.

Whereas the present embodiments have been described for use with a fuel card, or a credit card, it will be understood that a Vault Card™ is also envisaged for use with the described embodiments. Such a Vault Card™ has numeric keys to allow verification of a pin number. It is also envisaged that cards having a biometric reader can be used with the described embodiments.

It will be appreciated that any of the features of any of the embodiments of the invention, may also be used with other embodiments of the invention.

1-47. (canceled)

48. A method of generating an indicator that there is an anomaly between vehicle data and fuel card usage data, the method comprising:
receiving the vehicle data at a computer;
receiving the fuel card usage data at the computer;
using the computer to compare the vehicle data with the fuel card usage data according to a set of rules accessible by the computer to determine if there is the anomaly between the vehicle data and the fuel card usage data; and
automatically generating using the computer the indicator if the anomaly between the vehicle data and the fuel card usage data is determined.

49. The method of claim 48, wherein using the computer to compare the vehicle data with the fuel card usage data comprises using at least one of a representation of the vehicle data or a representation of the fuel card usage data to make the comparison.

50. The method of claim 48, wherein using the computer to compare the vehicle data with the fuel card usage data comprises: converting using the computer at least one of the vehicle data or the fuel card usage data into a unit that can be compared with the other of the vehicle data and the fuel card usage data.

51. The method of claim 50, wherein the computer converts the vehicle data into a value or a range of values; the value or the range of values identifies an amount of fuel that a vehicle has used.

52. The method of claim 51, wherein converting using the computer comprises using a database to convert the vehicle data into the value or the range of values of fuel usage in order to identify the amount of fuel that the vehicle has used.

53. The method of claim 52, further comprising monitoring the amount of fuel used by the vehicle by monitoring at least one of one or more fuel injectors, a fuel pump or a fuel flow sensor of an engine of the vehicle.

54. The method of claim 48, wherein the set of rules comprises rules to generate a first range of values that correspond to the vehicle data, and a second range of values that correspond to the fuel card usage data, and wherein the anomaly is determined if the first range of values and the second range of values do not overlap.

55. The method of claim 48, wherein the set of rules comprises instructions to compare a threshold value with a difference between the vehicle data and the fuel card usage data or one or more representations of the vehicle data and one or more representations of the fuel card usage data; and the set of rules further comprise instructions to cause exceeding the threshold value to cause the anomaly to be determined.

56. The method of claim 55, wherein the set of rules further comprises more than one threshold value; and automatically generating using the computer the indicator comprises: exceeding more than one threshold value causes differentiated anomalies with increasing levels of severities to be determined; and the differentiated anomalies comprise the anomaly.

57. The method of claim 48, further comprising receiving at the computer an identifier associated with a vehicle; and using the identifier to determine which of the set of rules should be applied for the vehicle when comparing the vehicle data with the fuel card usage data.

58. The method of claim 48, wherein receiving the fuel card usage data comprises: using fuel card usage data from a pre-paid fuel card for providing the fuel card usage data substantially in real time.

59. The method of claim 48, further comprising using a fuel card having data relating to a driver identification.

60. The method of claim 48, further comprising using the indicator to immobilise or mobile the vehicle.

61. An apparatus arranged to carry out the method of claim 48.

62. A method of generating an invoice for fuel dispensed from a first fuel pump, the method comprising:
receiving an identifier from a vehicle at the first fuel pump;
dispensing fuel by the first fuel pump;
associating the fuel dispensed by the first fuel pump with the identifier; and
generating the invoice for the fuel dispensed by the first fuel pump to a party associated with the identifier.

63. The method of claim 62, further comprising a plurality of dispensing fuel operations by one or more second fuel pumps before generating the invoice, wherein: the one or more second fuel pumps comprises the first fuel pump; and the plurality of dispensing fuel operations comprises dispensing the fuel by the first fuel pump.

64. The method of claim 62, wherein the identifier comprises at least one of:
billing information for a driver or an employer of the driver;
the name of the driver;
the name of the employer of the driver;
a registration number of the vehicle;
a vehicle identification number (VTN);
a distance traveled by the vehicle;
an account number for the vehicle;
an account number for the driver; or
an invoice-to address.

65. A first fuel pump arranged to carry out the method according to claim 62.

66. A method of purchasing fuel at a service station, the method comprising:
obtaining a first code by making a prepayment;
inserting the first code in a memory of a computer and being allocated a special code for use in verifying an identity of a user when purchasing the fuel;
communicating with the computer when fuel is required to be purchased;
inputting the special code for verification;
verifying at the computer by checking the special code and comparing the prepayment less any deductions for previous fuel purchases, the deductions for the previous fuel purchases are stored in the memory;
authorising a first payment for the fuel in response to the verification;
monitoring a remaining amount, where the remaining amount is the prepayment less the first amount and the deductions for the previous fuel purchases; and
not authorising a second payment when the prepayment has been spent.

67. The method according to claim 66 further comprising cross-referencing the prepayment with vehicle telematics data to generate an indicator that there is an anomaly with the vehicle telematics data.

68. The method according to claim 67 wherein the vehicle telematics data and the prepayment data is provided in a single special server or in two respective special servers in communication with the each other.

69. A system arranged to carry out the method of claim 66.

70. A method of paying for at least one of goods, services or charges using a payment card, the method comprising:
receiving vehicle data at a computer;
receiving payment card data at the computer;
using the computer to compare the vehicle data with the payment card data to determine whether there is sufficient credit to pay for the at least one of the goods, the services or the charges; and
using the computer to authorise payment if there is sufficient credit.

71. The method according to claim 70, further including arranging the payment card to pay for at least one of pre-specified goods, pre-specified services or pre-specified charges, wherein: the at least one of the goods, the services or the charges comprise the pre-specified goods, the pre-specified services or the pre-specified charges.

72. The method according to claim 71, further including using one or more codes to pre-specify the at least one of the goods, the services or the charges.

73. The method according to claim 70, further including arranging the payment card to make payments to one or more pre-specified vendors.

74. The method according to claim 70, further including using a Subscriber Identity Module (SIM) card as the payment card.

75. An apparatus to carry out the method of claim 70.
